(19) United States
(12) Patent Application Publication
(10) Pub. No.: US 2012/0092514 A1
(43) Pub. Date: Apr. 19, 2012

(54) IMAGE-CAPTURE DEVICE, A METHOD OF CORRECTING IMAGES, AND A NON-TRANSITORY COMPUTER-READABLE STORAGE MEDIUM

(75) Inventor: Benoît Vandame, Betton (FR)

(73) Assignee: CANON KABUSHIKI KAISHA, Tokyo (JP)

(21) Appl. No.: 12/907,879

(22) Filed: Oct. 19, 2010

(51) Int. Cl. H04N 5/228

(52) U.S. Cl. 348/222.1; 348/E05.031

(57) ABSTRACT

An image-capture device comprises a display for displaying images. The images for display are pre-processed based on a diopter value set in connection with a viewfinder of the image-capture device. The pre-processing of the displayed images allows a user to have a similar experience when looking through viewfinder and when looking at the display.

### BACKGROUND OF THE INVENTION

1. Field of the Invention

The present invention relates to an image-capture device, a method of correcting a displayed image, and a non-transitory computer-readable storage medium.

2. Description of the Related Art

Many modern digital cameras provide an optical viewfinder and a screen. The optical viewfinder is provided to allow a user to see the image that is going to be captured. In a Single Lens Reflex (SLR) camera, the camera re-directs light received through the lens to the viewfinder to allow the user to see some (maybe 90% or more) or all of the image that is going to be captured. In other, more compact, digital cameras the viewfinder may receive light directly from an opening in a front part of the camera via one or more lenses in order to allow the user to see the image that will be captured. In such cases the image seen by the user is only an approximation of the image that will be captured as the position of the opening in the front of the camera is different from that the lens, causing parallax error. Further, the optics of the viewfinder may different to that of the lens. In yet other types of camera there may be provided a digital viewfinder in which the user looks through a viewfinder opening in the camera body at a display that displays an image corresponding to an image being captured by the camera's light sensor. Such digital viewfinders are advantageous in that the user can see the same image that is being captured by the light sensor and the size of the camera can be kept quite small. A disadvantage of such cameras is that the quality of the image that can be viewed via the digital viewfinder is lower than on systems that rely solely on optics to deliver an image, such as an SLR.

A common feature of all the above viewfinders is that the user has to bring his eye close to an aperture in the back of the camera in order to look into the camera's viewfinder.

As mentioned above, in addition to a viewfinder, many digital cameras provide a screen. Such screens are typically LCD displays, but could in the future be OLED displays or other types of display. The displays are useful because they allow users to view photographs that have been taken or which are stored in the camera's memory, and to view and adjust setting in the camera. Some digital cameras provide a ‘live view’ function that allows images captured by the camera's light sensor to be displayed on the display on the back of the camera in real-time. Such a ‘live view’ function allows the display to be used to see the image that the camera would capture. For the purposes of the present application the term ‘viewfinder’ will be taken not to include such use of the display.

On higher end cameras a diopter adjustment is commonly provided on the viewfinder. This function is useful for camera users with imperfect vision. The diopter adjustment allows user to adjust the diopter (inverse of focal length) to correct for aberrations in the user's vision. In particular the diopter adjustment can be used to correct for short sightedness (Myopia) or long sightedness (Hyperopia). Users with Myopia can use the diopter adjustment to make it easier to see objects that are a significant distance away, whereas users with Hyperopia can use the diopter adjustment to make it easier to see objects that are nearby.

A difficulty for users of current digital cameras, particularly for users with Hyperopia, is that whilst they can take photos though the viewfinder without using their glasses or contact lenses after they have made a suitable diopter correction to the viewfinder, if they then need to perform operations on the display on the back of the camera they need to replace their glasses or contact lenses in order to view the display correctly. This repetitive process of removing and replacing glasses or contact lenses is inconvenient for the user.

“Focal pre-correction of projected image for deblurring screen image” by Yuji Oyamada and Hideo Saito, Graduate School of Science and Technology, Keio University, 3-14-1 Hiyoshi kohoku-ku, Yokohama 223-8522, Japan discloses a method for reducing out-of-focus blur caused by projector projection. This document discloses pre-correction of a projected image using a point spread function so that a screen can be de-blurred.

### SUMMARY OF THE INVENTION

According to a first aspect of the present invention there is provided an image-capture device comprising: a display unit; a viewfinder; a diopter-correction unit adapted to allow a user to set a diopter value and correspondingly adjust a diopter correction of the viewfinder; and a processor; wherein the processor is configured to pre-process images to be displayed on the display using the diopter value set using the diopter-correction unit.

According to a second aspect of the present invention there is provided a method for correcting images in an image-capture device comprising a display unit, a viewfinder, a diopter-correction unit, and a processor, the method comprising: setting a diopter value using the diopter-correction unit and correspondingly adjusting a diopter correction of the viewfinder; and the processor pre-processing images to be displayed on the display unit using the diopter value set using the diopter-correction unit.

According to a third aspect of the present invention there is provided a non-transitory computer-readable storage medium storing instructions for: reading a diopter value set using a diopter-correction unit, the diopter value corresponding to a diopter correction of a viewfinder; and pre-processing images to be displayed on a display unit using the diopter value.

### BRIEF DESCRIPTION OF THE DRAWINGS

An embodiment of the present invention will now be described, by way of example only, with reference to the accompanying drawings in which:

FIG. 1 shows a camera embodying the present invention;

FIG. 2 shows the construction of a viewfinder including a diopter unit of the camera;

FIG. 3 is a schematic diagram of the internal structure of the camera, and

FIG. 4 is a flowchart showing steps performed by the camera of the first embodiment;

### DESCRIPTION OF THE EMBODIMENTS

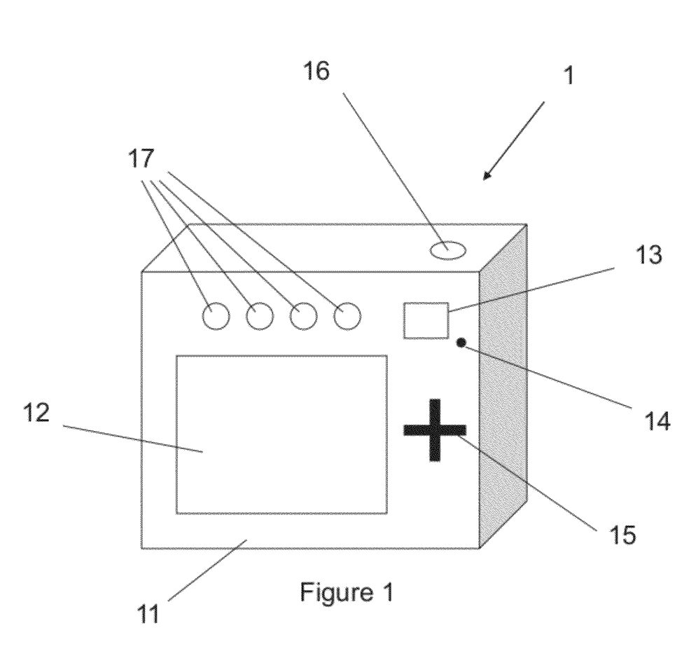

FIG. 1 shows an image-capture device in the form of a camera 1 comprising a main body 11, an LCD display panel 12, a viewfinder 13, a diopter adjustment wheel 14, a four-way rocker switch 15, a shutter-release button 16, and four control buttons 17.

The camera is an SLR camera with a detachable lens (not shown).

The four-way rocker switch 15 and control buttons are provided on the back side of the camera to allow a user to access and control functions of the camera, such as camera mode (program, aperture priority, shutter priority, etc.), shutter speed, aperture, white balance, ISO, red-eye correction, etc. These functions will not be described in detail as they are common to many cameras and are not particular to the present invention.

Although a still-image camera is shown in FIG. 1, in other embodiments the image-capture device may take the form of a video camera for capturing moving images.

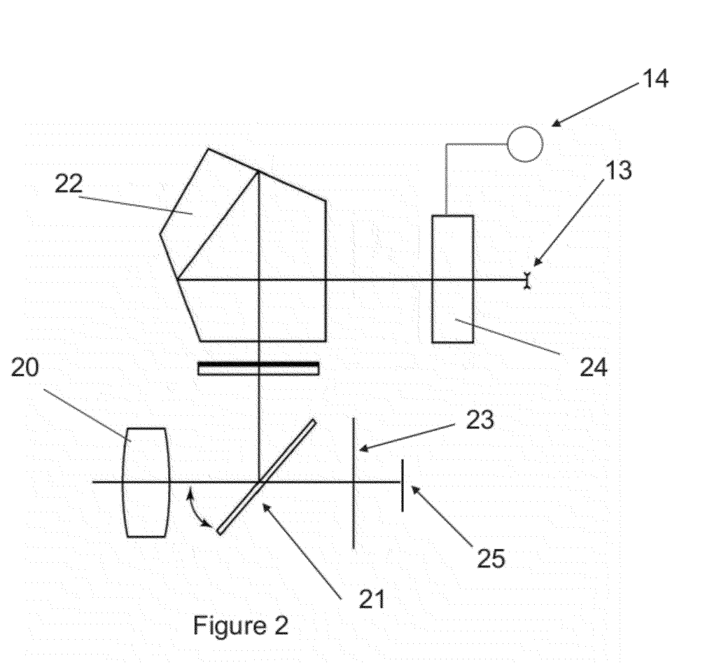

FIG. 2 is a simplified diagram showing the camera's optics 2. The optics 2 includes the viewfinder 13 and the diopter-adjustment wheel 14. The detachable lens 20 captures light from outside of the camera 1. The light is directed to a rotatable mirror 21. In normal operation, when a user is composing a photograph, the mirror 21 directs light to a prism 22. When the photograph is taken the mirror 21 flips up to allow light to pass through to the light sensor 25. A shutter 23 is provided between the rotatable mirror 21 and the light sensor 25 to control the light reaching the light sensor 25. The light sensor 25 is a CCD or CMOS light sensor of the type known in the art. When the mirror 21 is down light is reflected by the prism towards the viewfinder 13 via a diopter-lens unit 24. The diopter-lens unit 24 is adjustable by the diopter-adjustment wheel 14 to focus the light so that the diopter (the inverse of focal length) of the light reaching the viewfinder can be adjusted. The diopter-adjustment wheel is typically adjustable between −3 and +3.

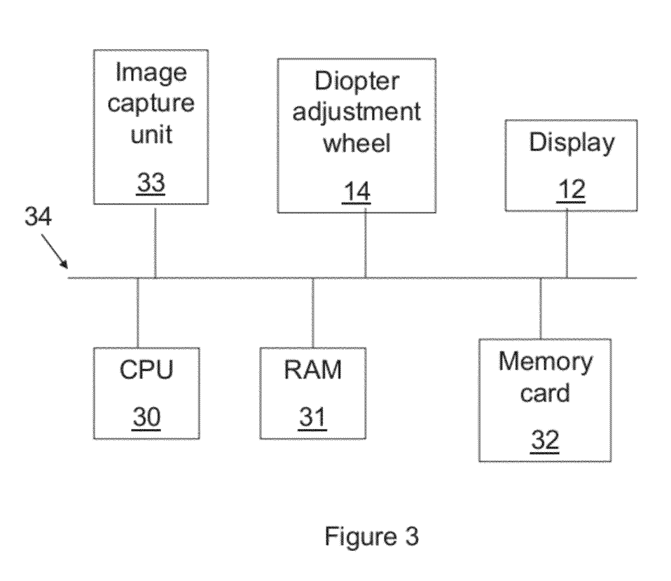

FIG. 3 shows how relevant components of the camera are electrically connected to each other. The camera comprises a CPU 30, RAM 31, and a removable memory card 32 connected to each other via a bus 34. There are also a number of other camera related parts connected to the bus that are represented generally by the image-capture unit 33. The diopter-adjustment wheel 14 and display 12 are also connected to the bus.

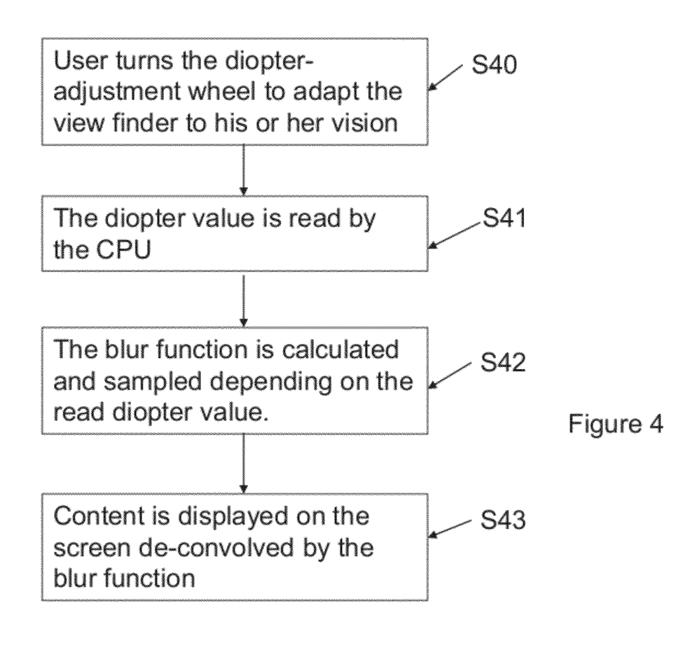

In use, the camera 1 is operable to display adjusted images on the display 12 to match the diopter adjustment set by the diopter-adjustment wheel 14. In this way a user may view images through the viewfinder 13 and images on the display 12 without the need to remove and replace his or her glasses or contact lenses. The steps to allow this display are shown generally in FIG. 4.

In step S40, a user adjusts the diopter-adjustment wheel in order to correct for a defect in his or her eyesight. The diopter-adjustment wheel is mechanically connected to a moveable diopter lens. Rotation of the diopter-adjustment wheel causes the diopter lens to move in predetermined increments. An electronic device is provided within the diopter lens unit 24 to read the position of the diopter lens and store a corresponding diopter value. This stored diopter value is read out by the CPU 30 of the camera is step S41.

In steps S42, the CPU computes and samples a blur function corresponding to the read diopter value. In step S43, content to be displayed on the display 12 is de-convolved using the sampled blur function in order to display a corrected content image on the display 12.

Before describing each of the steps in detail, some background information concerning image correction will be provided.

The human eye includes a light sensitive part called the retina. The retina includes two types of light sensitive cells known as rods and cones. The rods and cones have different roles in vision depending on the intensity of available light. Like other imaging systems the eye can be thought of as a combination of a lens and a light sensitive detector (the retina). Accordingly, when light is well focused, light from a point being looked at should be focused onto a corresponding point on the retina. If the eye is unable to focus in this manner, the light from a point being looked at appears blurred on the retina. This blurring can be modeled using a point spread function (PSF).

We can model light being projected onto the eye when the light is not properly focused as follows. Let I be a sharp image and P be a blur function caused by an aberration of the naked eye. An image V, formed inside the eye, is defined by:

V=I\textcircled{x}P

where \textcircled{x} denotes the convolution operator. The image V will seem blurry to the user in the absence of image correction such as contact lenses or glasses.

It is known [“Image pre-compensation to facilitate computer access for users with refractive errors”, Alonso, Jr., Miguel and Barreto, Armando and Cremades, J. Gualberto, SIGAACCESS Access. Comput. 2004, Volume No. 77-78, pages 126-132] to generate a corrected image, I_{c}, by performing a convolution of I with the inverse of P.

I_{c}=I\textcircled{x}P⁻¹

The image formed inside the eye, V_{c}, is equal to:

V_{c}=I_{c}\textcircled{x}P

V_{c}=(I\textcircled{x}P⁻¹)\textcircled{x}P=I\textcircled{x}(P⁻¹\textcircled{x}P)=I

Accordingly, an image can be pre-adjusted to compensate for a known visual aberration in order to provide a user with a relatively sharp image.

Now the background has been described, a description of the embodiment continues. Step S40 requires little additional explanation. The user looks through the viewfinder 13 and moves the diopter-adjustment wheel 14 to a desired value to correct of the user's imperfect vision.

In step S41, the CPU reads a diopter value set by the user using the diopter-adjustment wheel 14.

In step S42, the camera calculates and samples a blur function. In the present embodiment a relatively simple blur function is used. However, as will be apparent to those skilled in the art, a more complicated blur function could be used. Such more a complicated blur function may take into account the distance from the eye to the display 12 and/or the size of the pixels on the display. The blur function P used in the embodiment is defined as follows:

P(x,y)=e^{-(x}^{²}^{+y}^{²}^{)/d} for d>0

P(x,y)=δ(x,y) for d≦0

Where δ(x,y) is the Dirac delta function and d is the diopter value read from the diopter-adjustment wheel 14. x and y are co-ordinate values on the display. The reason that the blur function is chosen to be zero for negative diopter values is that the display 12 of the camera is likely to be held quite close to the user (typically around 40 cm from the eye) so that correction for short-sighted users is unnecessary.

The blur function P for the detected diopter value d is then sampled to form a small image (collection of values for different x, y) to be used to determine the corrected image I_{c}.

In step S43, content to be displayed on the display 12 is prepared according to the following method, starting with an original image. The original image, I, is subjected to de-convolution using the van-Cittert de-convolution algorithm. The van-Cittert de-convolution algorithm is an iterative process, which follows the following series of steps:

$$\{ \begin{matrix}{O}_{0} = I \\ {O}_{n + 1} = {O}_{n} + I - {O}_{n} ⊗ P\end{matrix}$$

where O₀ is the content to be displayed and subsequent iterations Oₙ increasingly approximate the de-convolved image. In practice around ten iterations is enough to provide a reasonable approximation of the de-convolved image for display.

A feature of the de-convolved image is that it has a high dynamic range, which it may not be possible to display on the display 12. The dynamic range of the display 12 is typically quantified between 0 and 255 (8 bit color). Accordingly, a post filtering step is performed on the de-convolved image I_{c}.

O₁₀=I_{c}

The post-filtering step consists of setting R, G, or B values of pixels of I_{c} that exceed 255 to have a value of 255. After post-filtering the image I_{c} is displayed on the display 12.

It is worth noting at this stage that the de-convolution process in this embodiment is not perfect. The method used to calculate the de-convolution (Van-Cittert) generates an approximation and the dynamic range of the result is limited by the post-filtering step described above. In fact the de-convolution process is unstable such that for diopter values greater than 2, the de-convolution will not be perfect. Nevertheless, despite these imperfections, the image I_{c} displayed to a user will provide a similar diopter correction to that set for the viewfinder, allowing the user to avoid the need to use glasses or contact lenses when viewing the display 12.

In the first embodiment of the present invention, in step S42 a blur function was calculated and sampled. According to a second embodiment of the present invention this step may be replaced by the step of reading a previously stored look-up table. In the second embodiment the diopter-adjustment wheel 14 is operable to set a number of predetermined values. In this embodiment, the diopter-adjustment value is settable as −3, −2, −1, 0, 1, 2, and 3. However, in other embodiments the diopter-adjustment value may be settable in 0.5 increments or in some other increment. The camera 1 stores look-up tables corresponding to sampled values of the blur function for the diopter correction values that are settable by the diopter-adjustment wheel 14. Thus in the second embodiment, rather than calculating and sampling the blur function for a user set diopter-adjustment value, the appropriate previously stored and sampled blur function is selected and read-out.

In further embodiments of the present invention the invention may be provided in the form of instructions stored on a computer-readable storage medium. The computer-readable storage medium may take the form of a CD-ROM, floppy disk, hard disk or any other suitable computer-readable medium. The program may be firmware for the camera 1 or may take the form of an upgrade of the firmware of the camera 1 in which the features of the above-described method are implemented.

1. An image-capture device comprising:
a display unit;
a viewfinder;
a diopter-correction unit adapted to allow a user to set a diopter value and correspondingly adjust a diopter correction of the viewfinder; and
a processor;
wherein the processor is configured to pre-process images to be displayed on the display using the diopter value set using the diopter-correction unit.

2. An image-capture device according to claim 1, wherein the processor is configured to pre-process images by obtaining a blur function corresponding to the diopter value and pre-correcting the images to be displayed using the obtained blur function.

3. An image-capture device according to claim 2, wherein the blur function is a point spread function.

4. An image-capture device according to claim 2, wherein the pre-correcting of the image to be displayed is performed by de-convolving the image to be displayed with the obtained blur function.

5. An image-capture device according to claim 4, wherein the de-convolving includes using the Van-Cittert algorithm to de-convolve the image to be displayed with the blur function.

6. An image-capture device according to claim 2, wherein the processor is configured to obtain the blur function by reading out a stored look-up table including sampled values of the blur function corresponding to the set diopter value.

7. A method for correcting images in an image-capture device comprising a display unit, a viewfinder, a diopter-correction unit, and a processor, the method comprising:
setting a diopter value using the diopter-correction unit and correspondingly adjusting a diopter correction of the viewfinder; and
the processor pre-processing images to be displayed on the display unit using the diopter value set using the diopter-correction unit.

8. A non-transitory computer-readable storage medium storing instructions for:
reading a diopter value set using a diopter-correction unit, the diopter value corresponding to a diopter correction of a viewfinder; and
pre-processing images to be displayed on a display unit using the diopter value.
